(19) United States
(12) Patent Application Publication
(10) Pub. No.: US 2016/0297443 A1
(43) Pub. Date: Oct. 13, 2016

(54) CONTROL APPARATUS FOR VEHICLE AND CONTROL METHOD THEREOF

(71) Applicant: TOYOTA JIDOSHA KABUSHIKI KAISHA, Toyota-shi, Aichi-ken (JP)

(72) Inventor: Hirokazu KATO, Nisshin-shi (JP)

(73) Assignee: Toyota Jidosha Kabushiki Kaisha, Toyota-shi, Aichi-ken (JP)

(21) Appl. No.: 15/037,731

(22) PCT Filed: Nov. 19, 2014
(86) PCT No.: PCT/IB2014/002497

§ 371 Date: May 19, 2016

(30) Foreign Application Priority Data
Nov. 21, 2013 (JP) 2013-241190

(51) Int. Cl. B60W 30/18; B60W 10/06; B60W 10/184; B60T 7/12

(52) U.S. Cl. CPC B60W 30/18018; B60T 7/122; B60W 10/06; B60W 10/184; B60T 2201/06; B60W 2540/10; B60W 2710/182; B60W 2710/06; B60W 2540/12

(57) ABSTRACT

A control apparatus for a vehicle includes: a stop-restart unit that stops an engine if an engine stop condition is satisfied and that restarts the engine if a restart condition is satisfied; a braking force maintenance unit that maintains a braking force for stopping the vehicle; and a braking force reduction unit that reduces the maintained braking force in different manners depending on whether or not the engine is restarted by the stop-restart unit, in the case where the vehicle is being braked by the braking force maintenance unit.

### BACKGROUND OF THE INVENTION

1. Field of the Invention

The present invention relates to a pressure reduction control of a control apparatus for a vehicle having an idling stop function and a vehicle stop maintaining function.

2. Description of Related Art

An idling stop technology in which an engine is stopped while a vehicle is stopped by a driver's operation on a brake pedal is known. Also, a technology in which the engine that has been stopped by the idling stop technology is restarted when the driver's foot is moved away from the brake pedal is known. The both technologies are collectively called idling stop function, start & stop function, engine-automatically-start-stop function, or the like (hereinafter, simply referred to as “idling stop function”).

In addition, there is also a technology in which the brake state of the vehicle is maintained even though the driver has moved his foot away from the brake pedal while the vehicle is being stopped, which is referred to as braking maintenance function and/or hill-start assistance (hereinafter, simply referred to as “vehicle stop maintaining function”), or the like. With this technology, when the vehicle is stopped before a traffic light, the driver does not need to depress the brake pedal, so the driver's fatigue may be alleviated.

In a vehicle in which the idling stop function and the vehicle stop maintaining function are both operatable, even if the engine is stopped by the idling stop function, when the driver actuates the vehicle stop maintaining function and moves his foot away from the brake pedal, the engine will be restarted through the idling stop function. Thus, it is difficult to make both the idling stop function and the vehicle stop maintaining function in operation.

Therefore, the current research is focused on how to bring both the idling stop function and the vehicle stop maintaining function into operation (for example, refer to Japanese Patent Application Publication No. 2007-040254 (JP 2007-040254A)). In JP 2007-040254A, an ECO-run control system is disclosed, in this system, in the case where the vehicle stop maintaining function is actuated while the engine is being stopped by the idling stop function, a switching is made so that the engine restart conditions do not include “foot being removed from the brake pedal”.

However, in the ECO-run control system of JP 2007-040254A, an issue of release of the braking force (a pressure reduction control) when both the idling stop function and the vehicle stop maintaining function are actuated is not taken into consideration.

FIGS. 1A and 1B are exemplary diagrams for illustrating the pressure reduction control for the idling stop function and the vehicle stop maintaining function. FIG. 1A shows the variation of the braking force in the pressure reduction control for the vehicle stop maintaining function. A constant braking force is maintained until the accelerator pedal is depressed, and is dramatically reduced by an ON operation on the accelerator pedal. That is, the timing at which the accelerator pedal is depressed coincides with the beginning of the pressure reduction (release of a holding request). The reason is that in the vehicle stop maintaining function, since the vehicle is in idle state, there is no excessive increase and rapid increase like the situation when the engine is started, so there will be a good response if the pressure reduction time is short. In other words, if the reduction time is prolonged, the start response will be degraded, and thus the driving performance is also degraded.

FIG. 1B shows the variation of the braking force in the idling stop function. Even in the case where the engine is stopped by the idling stop function, a braking force will also be applied to prevent the vehicle from being moved. Therefore, a constant braking force is applied until the accelerator pedal is depressed. As described above, when the vehicle stop maintaining function is in operation, due to an ON operation on the accelerator pedal, the engine will be started by the idling stop function. But when the engine is started, since the engine rotation speed will be higher than the idle rotation speed due to the excessive increase of the engine speed, a shock upon starting-off may occur due to the driving force. Therefore, the braking force is maintained for a predetermined period since the accelerator pedal is depressed, and then the pressure reduction begins (release of the holding request). In addition, the time for reducing the braking force (slope of the braking force) is also set to be longer than the time in the case of the vehicle stop maintaining function. By maintaining the braking force to some degree and then gradually reducing the pressure, the shock upon starting-off when the engine is started can be suppressed.

Thus, in the vehicle stop maintaining function and in the idling stop function, the pressure reduction control for the braking force is different. In addition, in the case where both the vehicle stop maintaining function and the idling stop function are in operation, the vehicle stop maintaining function will be activated by the driver's operation, but even when the vehicle is stopped and the vehicle stop maintaining function is in operation, the engine will not certainly be stopped by the idling stop function. On the other hand, whatever the situation, it is necessary to use the accelerator pedal being depressed as the premise for starting the completion of the pressure holding.

Therefore, for a vehicle in which the pressure reduction control is set at the vehicle stop maintaining function side, in the case where the engine is stopped, a shock upon starting-off may occur when the engine is started by the idling stop function. In contrast, for a vehicle in which the pressure reduction control is set at the idling stop function side, in the case where the engine is not stopped, the start response may be delayed.

### SUMMARY OF THE INVENTION

The present invention provides a control apparatus for a vehicle capable of improving the start performance even in the case where the idling stop function and the vehicle stop maintaining function are both equipped.

The present invention is a control apparatus for a vehicle including: a stop-restart unit that stops an engine if an engine stop condition is satisfied and that restarts the engine if a restart condition is satisfied; a braking force maintenance unit that maintain a braking force for stopping the vehicle; and a braking force reduction unit that reduces the maintained braking force in different manners depending on whether or not the engine is restarted by the stop-restart unit, in the case where the vehicle is being braked by the braking force maintenance unit.

A control apparatus for a vehicle capable of improving the start performance even in the case where the idling stop function and the vehicle stop maintaining function are both equipped can be provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIGS. 1A and 1B are exemplary diagrams for illustrating the pressure reduction control for the idling stop function and the vehicle stop maintaining function;

FIG. 2 is an exemplary flowchart for illustrating a schematic operation sequence of a control apparatus for a vehicle according to the present embodiment;

FIG. 3 is an exemplary block diagram for illustrating the units and functions of the control apparatus for a vehicle;

FIG. 4 is an exemplary block diagram of a BH control part and an S&S control part;

FIGS. 5A and 5B are exemplary flowcharts for illustrating the operation sequence of the BH control part and the S&S control part;

FIGS. 6A and 6B are exemplary flowcharts for illustrating the operation sequence of a braking control part;

FIGS. 7A and 7B are exemplary flowcharts for illustrating the operation sequence of a braking control part (second embodiment);

FIG. 8 is an exemplary diagram for illustrating the determination of the engine rotation speed in steps S132 and S160 in FIGS. 7A and 7B;

FIG. 9 is an exemplary flowchart for illustrating the operation sequence of a braking control part (third embodiment); and

FIG. 10 is an exemplary flowchart for illustrating the operation sequence of a braking control part (fourth embodiment).

### DETAILED DESCRIPTION OF EMBODIMENTS

Hereinafter, the mode for carrying out the present invention will be described by way of the embodiment thereof, in connection with the attached drawings.

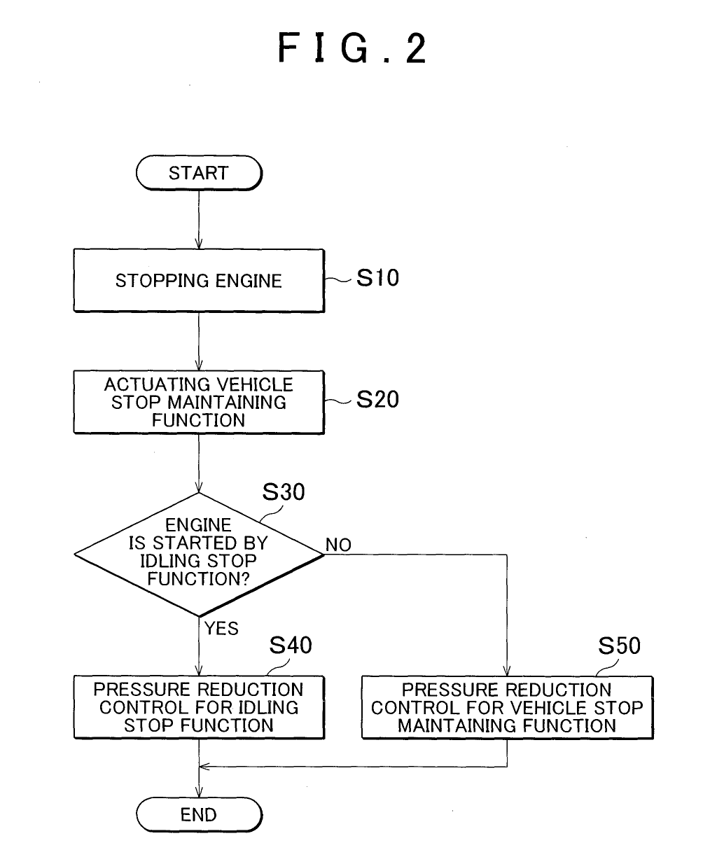

FIG. 2 is an exemplary flowchart for illustrating a schematic operation sequence of a control apparatus for a vehicle according to the present embodiment.

In the case where the vehicle is stopped and an engine stop condition is satisfied, the engine is stopped by the idling stop function in the control apparatus for a vehicle (S10).

When the vehicle is stopped, the driver actuates the vehicle stop maintaining function (S20). Thus, release of the brake pedal is excluded from the engine start conditions of the idling stop function, and the engine is started mainly by depressing the accelerator pedal.

The control apparatus for a vehicle determines whether or not the engine is started by the idling stop function (S30). In the case where the engine is started by the idling stop function, in addition to the ON operation on the accelerator pedal, other causes such as the remaining capacity of a battery being lowered, and so on are also considered, and the engine can be started by any of these causes.

In the case where the engine is started by the idling stop function (YES in S30), the control apparatus for a vehicle selects the pressure reduction control for the idling stop function to reduce the pressure (S40).

On the other hand, in the case where the engine is not started by the idling stop function (NO in S30), since the engine is not restarted, the control apparatus for a vehicle selects the pressure reduction control for the vehicle stop maintaining function to reduce the pressure (S50).

Therefore, in a vehicle in which both the vehicle stop maintaining function and the idling stop function is operatable, in the case where the vehicle stop maintaining function is in operation, by determining whether or not the engine is started by the idling stop function, the pressure reduction control can be suitably selected. It will be further described according to the situations. (i) In the case where the engine is stopped by the idling stop function, the vehicle stop maintaining function is brought into operation, and the engine is restarted by depressing the accelerator pedal, the pressure reduction control for the idling stop function is selected. (ii) In the case where the engine is not stopped by the idling stop function, the vehicle stop maintaining function is brought into operation, and the engine is not restarted by depressing the accelerator pedal, the pressure reduction control for the vehicle stop maintaining function is selected. (iii) In the case where the engine is stopped by the idling stop function and the vehicle stop maintaining function is not in operation or has not yet been in operation, the engine is restarted by the idling stop function through release of the brake pedal. Since the vehicle stop maintaining function is not in operation, no problem will occur, and the pressure reduction control either for the vehicle stop maintaining function or for the idling stop function can be selected (varied according to the determination method). (iv) In the case where the engine is not stopped by the idling stop function and the vehicle stop maintaining function is not in operation, since neither the idling stop function nor the vehicle stop maintaining function is in operation, no pressure reduction control is performed, and the present embodiment is not applicable.

In the following embodiments, the particular determination method in steps S20 and S30 will be further described.

In addition, in the pressure reduction control, although it is preferred to reduce the wheel cylinder pressure to zero, it is also possible that the pressure is not reduced to zero, as long as the pressure is reduced to such an extent that a travelling will not be inhibited.

### First Embodiment

### Structural Example

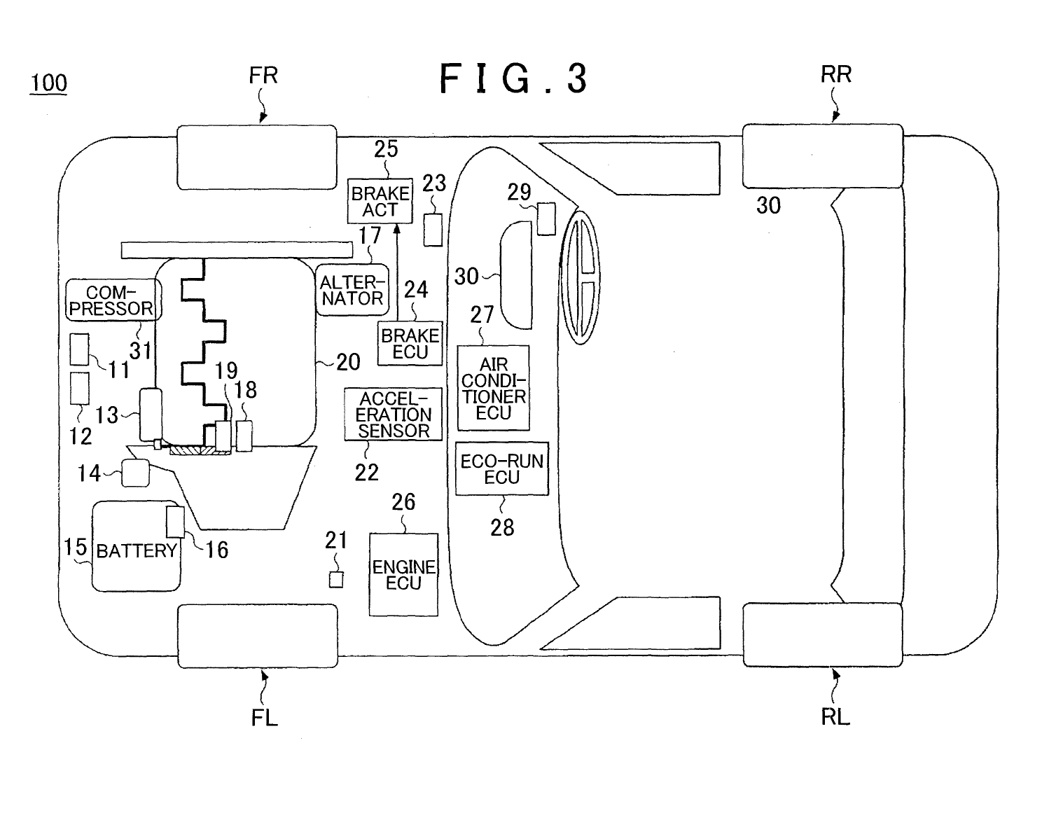

FIG. 3 is an exemplary block diagram of the units and function of the control apparatus 100 for a vehicle according to the present embodiment. These units and functions are not necessarily all used for the idling stop function or the vehicle stop maintaining function, and the configuration position and/or shape are only schematically shown. In addition, ECUs and/or sensors are communicatively connected via an on-board network such as CAN (Controller Area Network), or via dedicate lines.

The battery 15 is a power storage device (secondary battery) capable of charging and discharging. The battery 15 is, for example, a lead storage battery, which supplies power to an electric oil pump 14, a brake hydraulic pump (not shown), a tandem starter 13 and various ECUs (Electronic Control Units). In addition, the battery 15 is charged by the power generated by an alternator 17. The SOC of the battery 15 is monitored by a battery sensor 16.

The engine 20 is equipped with the electric oil pump 14, the tandem starter 13, a compressor 31 for an air conditioner, the alternator 17, a cam angle sensor 18, and a crank angle sensor 19. The tandem starter 13 is used to start the engine 20 by consuming the power from the battery 15. In the case where the engine rotation speed is high, the tandem starter 13 pushes out a pinion after bringing it into rotation so as to make it engage with a ring gear, such that the engine 20 can be started even during rotation of the engine. In addition, a starter without the function to rotate the pinion may also be equipped.

The alternator 17 is a power generator which generates electric power by being rotated in associated with the rotation of the crankshaft. A transmission belt is wound around the crankshaft and the rotation shaft of the alternator 17, and the alternator 17 is rotated by the power of the engine 20. The electric power generated by the alternator 17 is charged into the battery 15.

In addition, a transmission belt is wound around the compressor 31 of the air conditioner and the crankshaft, and the compressor 31 is rotated by the power of the engine 20.

The electric oil pump 14 is driven by the battery 15, and circulates the engine oil when the engine is stopped, whereby an uneven distribution of the engine oil during the stop of the engine is prevented, and the engine 20 is cooled during the stop of the engine.

The crank angle sensor 19 detects the crank angle, and the cam angle sensor 18 detects the cam angle. By identifying the crank angle and the cam angle, the so-called cylinder determination can be performed. For example, since the timing at which the respective cylinders reach the top-dead point is identified, the cylinder into which, fuel is injected and combusted can be determined upon start of the engine. In addition, the crank angle sensor 19 is used to detect the engine rotation speed.

An engine hood lock SW 12 and a distance sensor 11 are provided in the front of the vehicle. The engine hood lock SW 12 is a sensor used to detect whether or not the engine hood is locked. When the engine hood is opened, the start of the engine is disabled by the idling stop function because the driver cannot observe the front.

The distance sensor 11 is, for example, a millimeter wave radar, a laser radar, a stereo camera, a TOF (Time of Flight) camera, or the like, and is a sensor used to detect the distance to an object. Besides the distance, relative speed and azimuth can also be obtained therefrom. An inter-vehicle distance control function enables a host vehicle to follow a preceding vehicle while maintaining the distance corresponding to the vehicle speed of the host vehicle.

The engine ECU 26 is an ECU for controlling the engine 20, and is connected with a tandem starter driving relay 21. When the engine ECU 26 energies the tandem starter driving relay 21, the tandem starter 13 operates to start the engine 20.

The brake ECU 24 controls a brake ACT 25 to control the wheel cylinder pressure at each wheel. The brake ACT 25 has an electric pump (not shown) for generating a hydraulic pressure, and has a pressure increasing valve, a pressure reduction valve and a pressure maintaining valve for each wheel. By controlling the opening degree of the pressure increasing valve, the pressure reduction valve or the pressure maintaining valve, the wheel cylinder pressure can be increased, reduced or maintained for each wheel. The brake ECU 24 performs the control relating to the vehicle stop maintaining function by this function. In addition, a VSC (Vehicle Stability Control) control, an ABS control, a TRC control, and so on, can also be performed. Moreover, in the VSC control, the wheel cylinder pressure of the respective wheels is controlled in such a manner that unstable vehicle behaviors such as excessive under-steering or over-steering of the host vehicle are prevented. In addition, the brake ECU 24 and the brake ACT 25 may be configured to supply the hydraulic pressure accumulated in an accumulator or the like to the respective wheel cylinders according to the depression force on the brake pedal by the driver, so as to brake the respective wheels.

The brake booster negative pressure sensor 23 is a sensor that detects a booster negative pressure generated by an intake air negative pressure of the engine 20. By using this negative pressure, the depression force on the brake pedal by the driver can be boosted, so that the brake pedal can be reliably depressed by the driver. If the booster negative pressure becomes larger (approach to atmospheric pressure), the idling stop function will start the engine 20 to reduce the booster negative pressure, so as to prepare for the driver's operation on the brake pedal.

The acceleration sensor 22 is a sensor that detects the acceleration in fore-aft direction or in right-left direction, and is used to calculate the inclination angle (slope) of the road surface on which the vehicle is stopped. The braking force for keeping the vehicle stop state is corrected according to the slope.

The air conditioner ECU 27 performs the so-called air conditioning control that controls the temperature inside the cabin to a temperature set by the driver. In the case where the engine 20 is stopped by the idling stop function, since the compressor 31 of the air conditioner is stopped, the air conditioner is switched to an air blowing function. In addition, during the air conditioning control performed by the air conditioner ECU 27 while a difference between the set temperature and the target temperature is large, the idle-stop function does not stop the engine 20.

The ECO-run ECU 28 is an ECU that controls the idling stop function. In the ECO-run ECU 28, a function to boost the voltage of the battery is integrated. When the engine 20 is started by the idle-stop function, since the voltage of the battery is lowered by the driving of the tandem starter 13, the ECO-run ECU 28 boosts the voltage of the battery in order to ensure the required voltage for other auxiliaries (ECUs, in-cabin lights, and so on). In addition, a configuration in which the idling stop function is controlled by using various ECUs such as the engine ECU may also be conceived.

The ECO-run canceling SW 29 is a switch for canceling the idling stop function. If the driver operates the ECO-run canceling SW 29 to be ON, the idle-stop function is turned off (the engine will not stop).

In addition, various operation status of the vehicle stop maintaining function and the idling stop function and/or alarm messages can be displayed on a dashboard 30, and a warning light is turned on. In addition to the dashboard 30, alarm messages and/or alarm sound may also be output from a speaker.

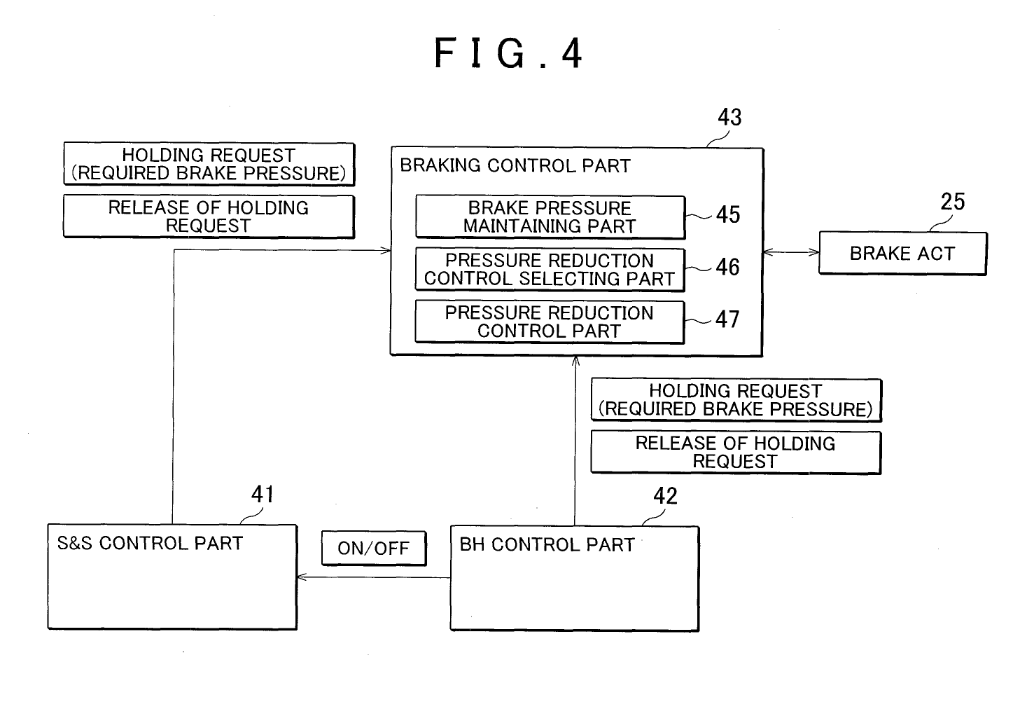

FIG. 4 is an exemplary functional block diagram of an S&S control part 41, a BH control part 42 and a braking control part 43. There functions can be implemented by executing the program stored in the ROM through the CPUs in the respective ECUs and cooperating with various hardwares.

The S&S control part 41 is a function mainly implemented by the ECO-run ECU 28. The BH control part 42 and the braking control part 43 are the functions mainly implemented by the brake ECU 24. However, in which ECU the respective functions are built can be suitably designed. In addition, all these function can be built in a single ECU. In addition, it may be that the BH control part 42 has the braking control part 43. That is, it would be enough if these functions are included in the vehicle.

The S&S control part 41, the BH control part 42 and the braking control part 43 are communicated with each other via the on-board network (CAN, FlexRay, LIN, Ethernet (registered trademark), etc.) by using ECUs, so as to transmit and receive various data. The S&S control part 41 obtains the information about the start (ON) of a braking maintenance (ON) by the BH control part 42 and the completion (OFF) of the braking maintenance.

The BH control part 42 determines whether or not the vehicle stop maintenance actuation operation is carried out while the vehicle is stopped, and if yes, outputs a holding request to the braking control part 43. The holding request is a request for a braking force to maintain a vehicle stop state during the engine is in idle state, as described up to now. The BH control part 42 outputs a required brake pressure, which is calculated according to the idle rotation speed of the engine and corrected according to the inclination of the road, surface etc., to the braking control part 43. In addition, in the case where an operation for stopping the braking maintenance (ON of the accelerator pedal) is detected, the BH control part 42 outputs a release of the holding request to the braking control part 43.

The S&S control part 41 determines whether or not an engine stop condition is satisfied, and stops the engine 20 when an affirmative determination is made. The S&S control part 41 also determines whether or not an engine start condition is satisfied in the case where the engine 20 is stopped, and starts the engine 20 when an affirmative determination is made. The engine stop condition includes such a condition that the vehicle speed is zero or is at or below a predetermined value, and such a condition that the brake pedal is depressed. However, as a stop disabling condition, there are conditions as follows: a condition that the air conditioner ECU prohibits the stop of the engine; a condition that the SOC of the battery 15 is at or below a threshold; a condition that the electrical load is at or above a threshold; a condition that the engine coolant temperature is at or below a threshold; a condition that the accelerator pedal is depressed; and so on.

The engine start condition varies depending on ON/OFF of the vehicle stop maintaining function. The engine start condition (in the case where the vehicle stop maintaining function is OFF) includes a situation where a changing from ON to OFF of the brake pedal is detected, a situation where the accelerator pedal is ON, a situation where the SOC of the battery 15 is lowered to a threshold or below, and a situation where the brake booster negative pressure becomes a threshold or above. The engine start condition (in the case where the vehicle stop maintaining function is ON) includes the situation where the accelerator pedal is ON, the situation where the SOC of the battery 15 is lowered to a threshold or below, and the situation where the brake booster negative pressure becomes a threshold or above. However, as a start disabling condition, there is a situation where the engine hood lock SW 12 is OFF, and so on. That is, in the case where the vehicle stop maintaining function is ON, in order that the engine 20 will not be operated by the idling stop function even if the driver moves his foot away from the brake pedal, the condition that a changing from ON to OFF of the brake pedal is detected is not be used as the engine start condition. However, by depressing the accelerator pedal, the engine 20 will be started by the idling stop function.

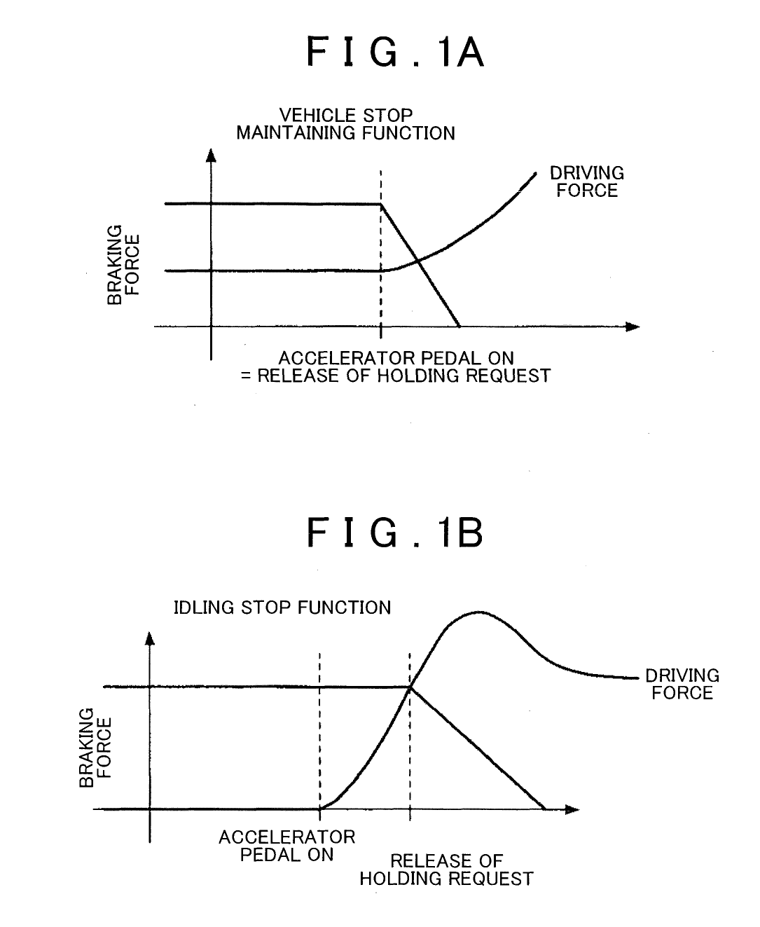

When the engine is stopped, the S&S control part 41 outputs a holding request to the braking control part 43. This holding request is different from the braking maintenance, and is a request for the braking force by which the vehicle is kept immobile during the engine is stopped. The S&S control part 41 outputs, for example, the maximum braking force in a predetermined time before the engine is stopped (a peak maintenance), to the braking control part 43 as a required brake pressure. The required brake pressure can be calculated by the brake ECU. In addition, as shown in FIG. 1B, when the engine start condition is satisfied (ON of the accelerator pedal), after a certain period has lapsed, the S&S control part 41 output a release of the holding request to the braking control part 43. In addition, when the vehicle stop maintaining function is OFF, the release of the brake pedal becomes an engine start condition, and after a certain period, the release of the holding request is output.

The braking control part 43 includes a brake pressure maintaining part 45, a pressure reduction control selecting part 46 and a pressure reduction control part 47. The brake pressure maintaining part 45 determines the braking force based on the holding request from the BH control part 42 and the S&S control part 41, and generates the braking force by using the brake ACT 25. To be specific, the larger one of the required brake pressures respectively from the BH control part 42 and the S&S control part 41 is employed. If the idling stop function has stopped the engine and the vehicle stop maintaining function is not in operation, the required brake pressure for the idling stop function is directly employed. If the idling stop function does not stop the engine and the vehicle stop maintaining function is in operation, the required brake pressure for the vehicle stop maintaining function is directly employed.

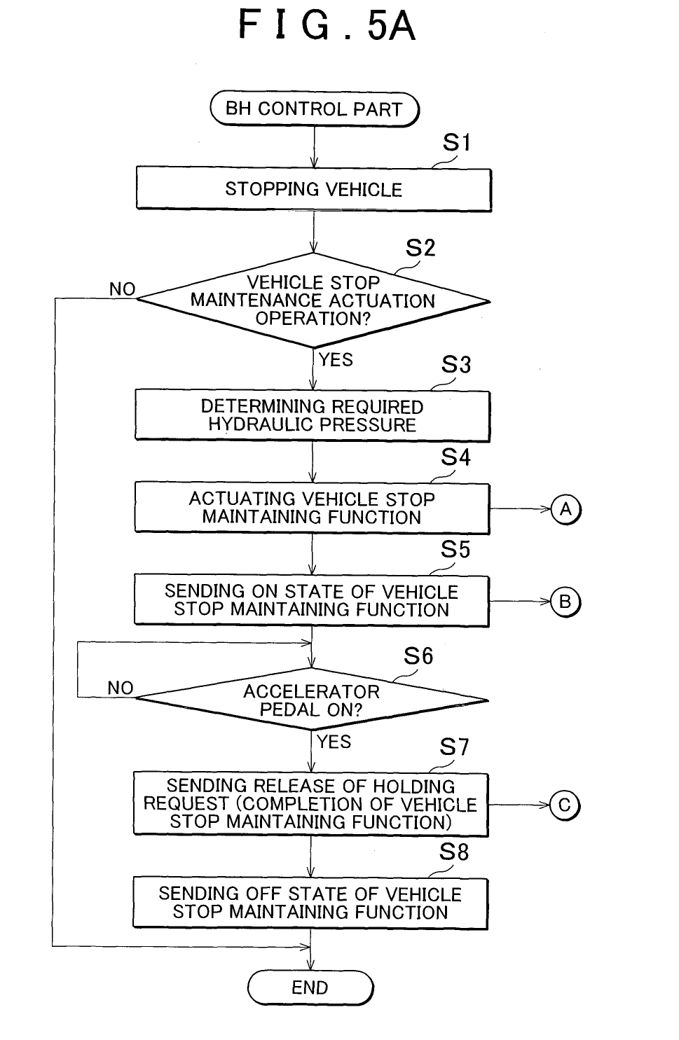

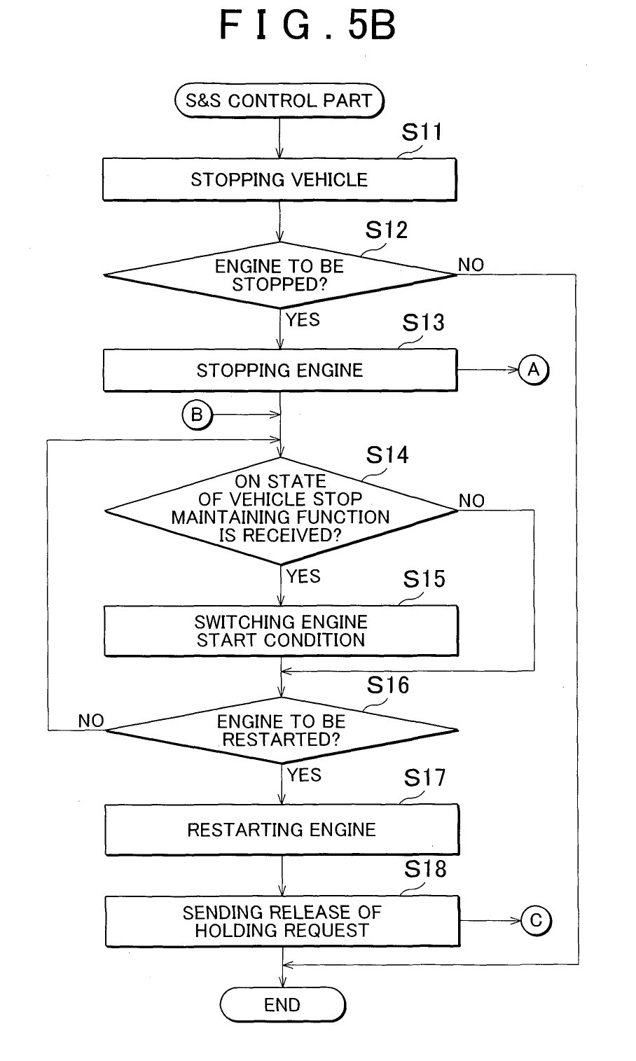

In the case where the release of the holding request is obtained from the control part which issued the holding request, the pressure reduction control selecting part 46 determines which one of the pressure reduction control for the vehicle stop maintaining function and the pressure reduction control for the idling stop function is to be selected, as will be described in detail below. The pressure reduction control part 47 uses the selected pressure reduction control to control the brake ACT 25 to reduce the pressure.

[About the vehicle stop maintaining function and the idling stop function] FIGS. 5A and 5B are exemplary flowcharts for illustrating the operation sequence of the BH control part 42 and the S&S control part 41.

During a traveling, the driver operates the brake pedal to stop the vehicle (S1).

When the vehicle is stopped (the vehicle speed becomes zero), the BH control part 42 determines whether or not there is a vehicle stop maintenance actuation operation (S2). The vehicle stop maintenance actuation operation is, for example, an operation by which the driver depresses the brake pedal with a depression force of a threshold or more. In addition, it may also be an operation of pressing a predetermined button. The BH control part 42 detects the value of the master cylinder pressure and/or the travel amount of the travel of the brake pedal to determine whether or not the vehicle stop maintenance actuation operation exists.

In the case where the vehicle stop maintenance actuation operation is detected (YES in S2), the BH control part 42 determines a required wheel cylinder pressure for vehicle stop maintenance (S3). When the vehicle is stopped with D range and the engine 20 is in idle state, it is preferred that a wheel cylinder pressure by which the vehicle will not be moved by the driving force incurred when the engine is started can be obtained. This wheel cylinder pressure is determined by the brake performance and/or the weight of the vehicle. In addition, it may be corrected according to the inclination angle of the road surface.

The BH control part 42 actuates the vehicle stop maintaining ng (S4). That is, the holding request and the required brake pressure (the determined wheel cylinder pressure) are output to the braking control part 43, thus the braking control part 43 utilizes the wheel cylinder pressure obtained by the driver's depression on the brake pedal while the vehicle is stopped, to maintain the wheel cylinder pressure determined for the vehicle stop maintaining function. In the case where the wheel cylinder pressure generated by depressing the brake pedal is smaller than the determined wheel cylinder pressure, since a braking force for stopping the vehicle is obtained, this wheel cylinder pressure is maintained. The driver can move his foot away from the brake pedal while the engine 20 is kept in operation, so the freedom degree of the driver's posture is improved upon short-time stopping.

The BH control part 42 sends the actuation of the vehicle stop maintaining function (the vehicle stop maintaining function is ON) to the S&S control part 41 (S5).

In addition, when the vehicle stop maintaining function is in operation, the BH control part 42 determines whether or not the accelerator pedal is operated (S6).

In the case where the accelerator pedal is operated (YES in S6), the BH control part 42 terminate the vehicle stop maintaining function (S7). That is, in the case where the accelerator pedal is operated, the BH control part 42 outputs a release request to the braking control part 43.

The BH control part 42 sends the termination of the vehicle stop maintaining function (the vehicle stop maintaining function is OFF) to the S&S control part 41 (S8).

Next, the S&S control part 41 will be described. During a traveling, the driver operates the brake pedal to stop the vehicle (S11). In addition, the vehicle being stopped in terms of the idling stop function generally indicates that the vehicle speed is zero; however, there is a technology in which the engine 20 is still stopped even when the vehicle velocity is above zero, as long as it is lower than a predetermined value. In the present embodiment, for the purpose of illustration, “the vehicle speed becoming zero” is used to determine that the vehicle is stopped.

Next, the S&S control part 41 determines whether or not to the engine 20 is to be stopped based on the engine stop condition (S12). In addition, the situation where the stop disabling condition is not satisfied is a precondition.

In the case where the engine stop condition is satisfied (YES in S12), the S&S control part 41 requests the engine ECU to stop the engine, so that the engine ECU 26 stops the injection of fuel to stop the engine 20 (S13). In addition, the S&S control part 41 outputs the holding request and the required brake pressure to the braking control part 43.

The S&S control part 41 determines whether or not the actuation of the vehicle stop maintaining function (the vehicle stop maintaining function is ON) has been received (S14).

In the case where the actuation of the vehicle stop maintaining function is received (YES in S14), the S&S control part 41 switches the engine start condition (S15). That is, the situation where the changing from ON to OFF of the brake pedal is detected is removed from the engine start conditions (the ON operation of the accelerator pedal remains). In the case where the actuation of the vehicle stop maintaining function is not received, the engine start condition remains as it is.

In the case where the engine 20 is stopped, the S&S control part 41 determines whether or not the engine 20 is to be restarted based on the engine start condition (S16). In addition, when the start disabling condition is satisfied, the engine 20 will not be started.

In the case where the engine start condition is satisfied and the start disabling condition is not satisfied, the S&S control part 41 restarts the engine 20 (S17). That is, since the S&S control part 41 requests the engine ECU 26 to restart the engine, the engine ECU 26 turns on the tandem starter driving relay 21 to restart the engine 20.

In addition, the S&S control part 41 outputs a release of the holding request to the braking control part 43 (S18). At this time, the information about which condition among the engine start conditions is satisfied may also be sent.

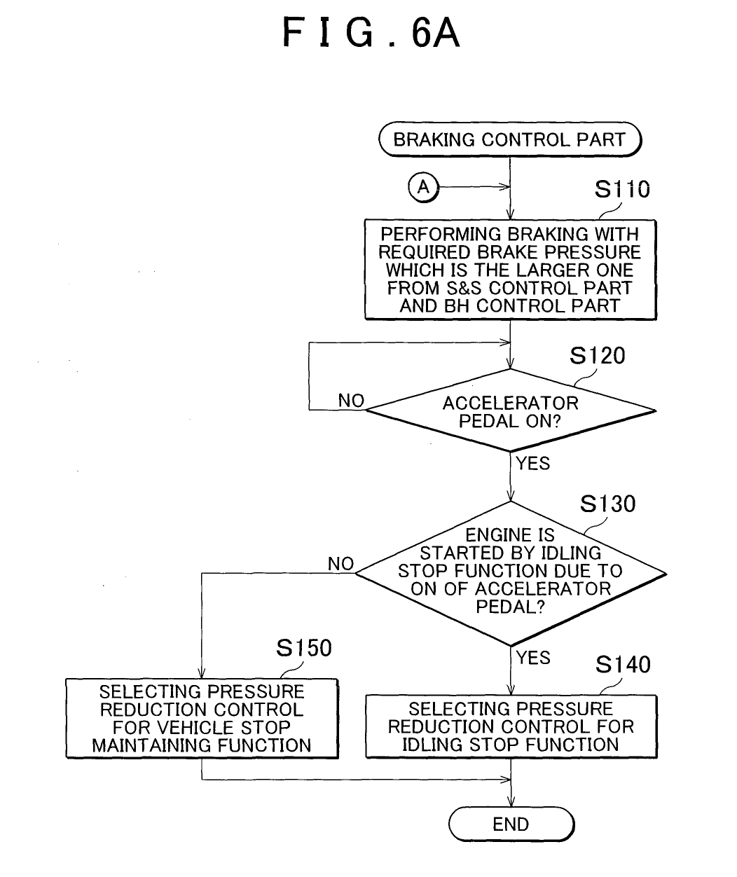

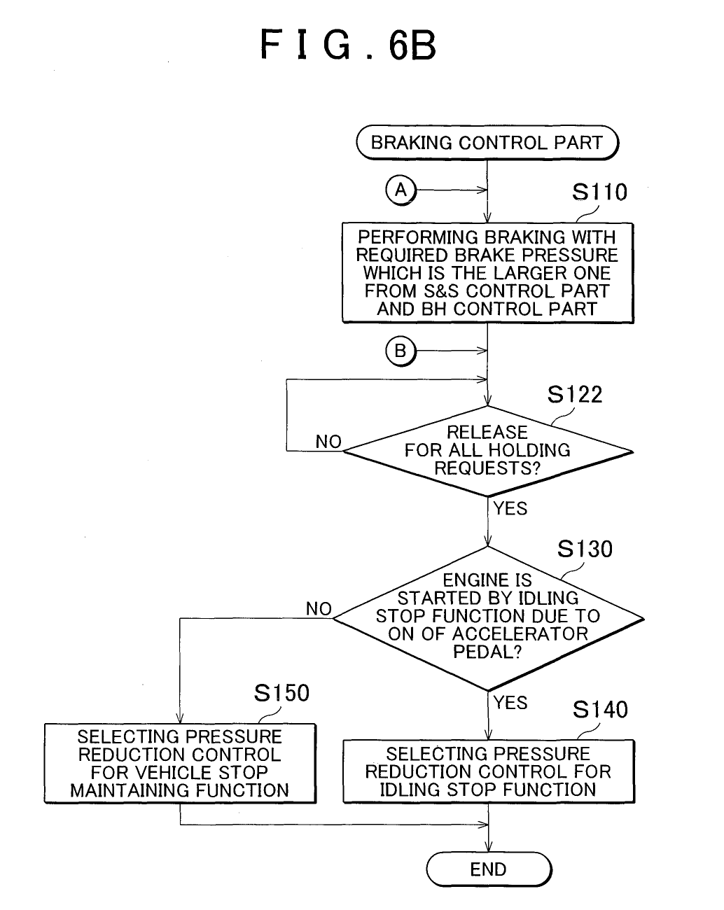

In this way, the braking control part 43, sometimes, receives the holding request and the release of the holding request respectively from the BH control part 42 and the S&S control part 41.

[Operation sequence of the braking control part] FIG. 6A is an exemplary flowchart for illustrating the operation sequence of the braking control part 43. In addition, the sequence in FIGS. 6A and 6B are applicable whatever the vehicle stop maintaining function is in operation or not.

The braking control part 43 performs braking with the larger one of the required brake pressures of the S&S control part 41 and the BH control part 42 (S110). In the case where the holding request is received only from one of the two parts, the braking is performed with the required brake pressure by the received holding request.

Moreover, in the case where the holding request is received from at least one of the idling stop function and the vehicle stop maintaining function, the pressure reduction control selecting part 46 determines whether or not the accelerator pedal is ON (S120). The reason lies in that, when both the idling stop function and the vehicle stop maintaining function are in operation, the engine start conditions for the idling stop function do not include OFF of the brake pedal any longer, and the engine is more likely started by ON of the accelerator pedal. The reason further lies in that, the vehicle stop maintaining function is cancelled by depressing the accelerator pedal. That is, in steps of FIG. 6A, instead of the release of the brake request, ON of the accelerator pedal is detected.

In the case where the accelerator pedal is ON (YES in S120), the pressure reduction control selecting part 46 determines whether or not the engine is restarted by the idling stop function due to ON of the accelerator pedal (S130). The start of the engine can be determined by the fact that the engine rotation speed detected by the crank angle sensor is increased from a value equivalent to zero to several hundreds RPM. In addition, it is also possible to enquire the S&S control part 41 and/or the ECUs such as the engine ECU about the start timing and/or the continuous operation time of the engine, or the like. In addition, the S&S control part 41 is enquired whether or not the engine is restarted due to ON of the accelerator pedal. This is because, ON of the accelerator pedal is only one of the engine start conditions, and sometimes, the S&S control part 41 may request the engine to be started due to other causes. For example, in the case where the engine is restarted by the idling stop function due to the decrease of the remaining capacity of the battery, as described below, the pressure reduction control for the vehicle stop maintaining function is selected. In this case, since the engine has been in operation before the accelerator pedal is depressed, it is preferred to select the pressure reduction control for the vehicle stop maintaining function. In addition, in the case where the engine is restarted by the idling stop function due to OFF of the brake pedal, as described below, the pressure reduction control for the vehicle stop maintaining function is selected (the vehicle stop maintaining function is not in operation). Since the engine has been started before the accelerator pedal is depressed, it is preferred to select the pressure reduction control for the vehicle stop maintaining function by which the pressure reduction begins from ON of the accelerator pedal.

In the case where the S&S control part 41 restarts the engine 20 due to ON of the accelerator pedal (YES in S130), the pressure reduction control selecting part 46 selects the pressure reduction control for the idling stop function (S140). That is, since the engine is restarted due to ON of the accelerator pedal, it can be deduced that both the idling stop function and the vehicle stop maintaining function are in operation, and thus, by delaying the pressure reduction, the shock upon starting-off can be suppressed.

In the case where the engine is not restarted by the S&S control part 41 due to ON of the accelerator pedal (NO in S130), the pressure reduction control selecting part 46 selects the pressure reduction control for the vehicle stop maintaining function (S150). That is, since the engine is not stopped at all or has been started by the idling stop function, by advancing the pressure reduction, the vehicle can be started with a good start response.

FIG. 6B is another exemplary flowchart of the operation sequence of the braking control part 43. That is, a control instead of that in FIG. 6A is illustrated.

The braking control part 43 performs braking with the larger one of the required brake pressures of the S&S control part 41 and the BH control part 42 (S110). In the case where the holding request is received from only one of the two parts, the braking is performed with the required brake pressure by the received holding request.

In the case where the holding request is received from at least one of the idling stop function and the vehicle stop maintaining function, the pressure reduction control selecting part 46 determines whether or not release of all the holding requests has been received (S122). Therefore, in the case where both the idling stop function and the vehicle stop maintaining function are in operation, it is determined whether or not release of the holding request has been received from the BH control part 42 and the S&S control part 41. A premise for release of the holding request is ON of the accelerator pedal (when only the vehicle stop maintaining function is in operation, or when both are in operation) or OFF of the brake pedal (when only the idling stop function is in operation).

In the case where release of all the holding requests has been received (YES in S122), the pressure reduction control selecting part 46 determines whether or not the engine is restarted by the idling stop function due to ON of the accelerator pedal (S130). The determination as to whether the engine is started due to ON of the accelerator pedal may be the same as that in FIG. 6A.

In the case where the engine is restarted by the idling stop function due to ON of the accelerator pedal (YES in S130), the pressure reduction control selecting part 46 selects the pressure reduction control for the idling stop function (S140). That is, since the engine is started due to ON of the accelerator pedal, it can be deduced that both the vehicle stop maintaining function and the idling stop function are in operation, and thus, by delaying the pressure reduction, the shock upon starting-off can be suppressed.

In the case where the engine is not started by the idling stop function due to ON of the accelerator pedal (NO in S130), the pressure reduction control selecting part 46 selects the pressure reduction control for the vehicle stop maintaining function (S150). That is, since the engine has already been started when the accelerator pedal is depressed or the engine is started due to OFF of the brake pedal and/or the remaining capacity of the battery (since the cause for starting the engine is not ON of the accelerator pedal), it is preferred to select the pressure reduction control for the vehicle stop maintaining function, like in FIG. 6A.

As described above, with the control apparatus for a vehicle according to the present embodiment, in the case where the engine is stopped by the idling stop function, if the engine is started due to ON of the accelerator pedal, the pressure reduction control for the idling stop function is selected, otherwise, the pressure reduction control for the vehicle stop maintaining function is selected, thereby it is possible to select a suitable pressure reduction control.

### Second Embodiment

In the first embodiment, the pressure reduction control is selected by determining whether or not the engine is started due to ON of the accelerator pedal. However, in the present embodiment, a control apparatus for a vehicle which selects the pressure reduction control based on the engine rotation speed will be described.

In addition, since the structural diagram and/or functional block diagram has the same function as that in the first embodiment, only the main constitution elements of the present embodiment will be mainly described.

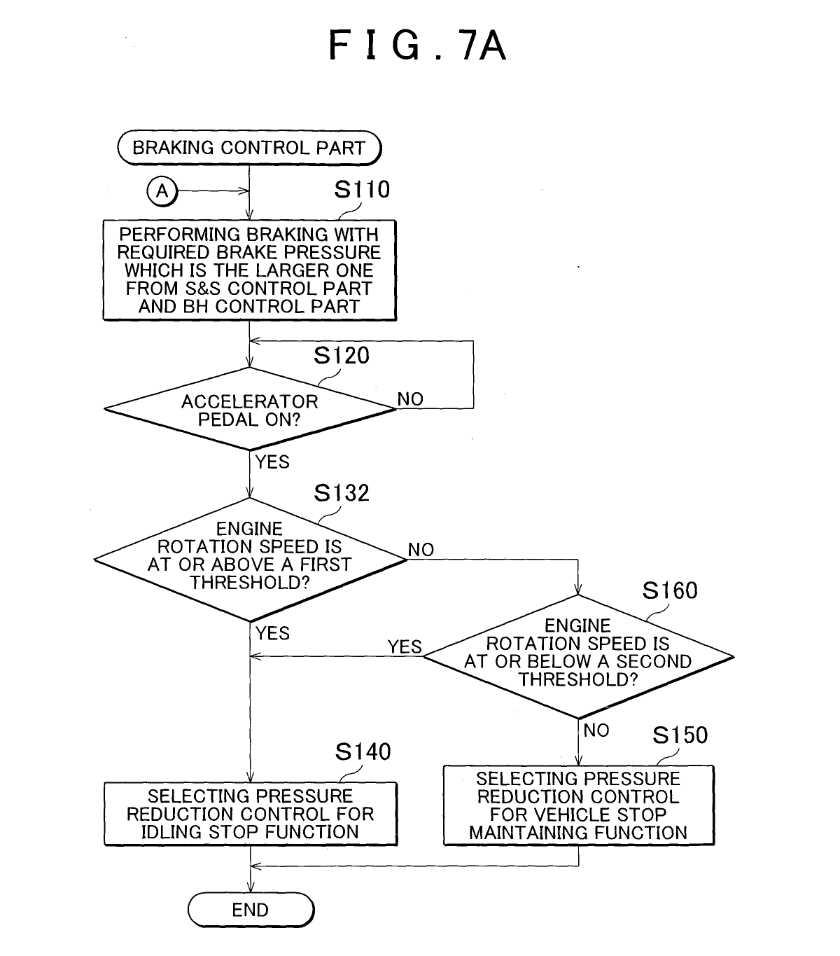

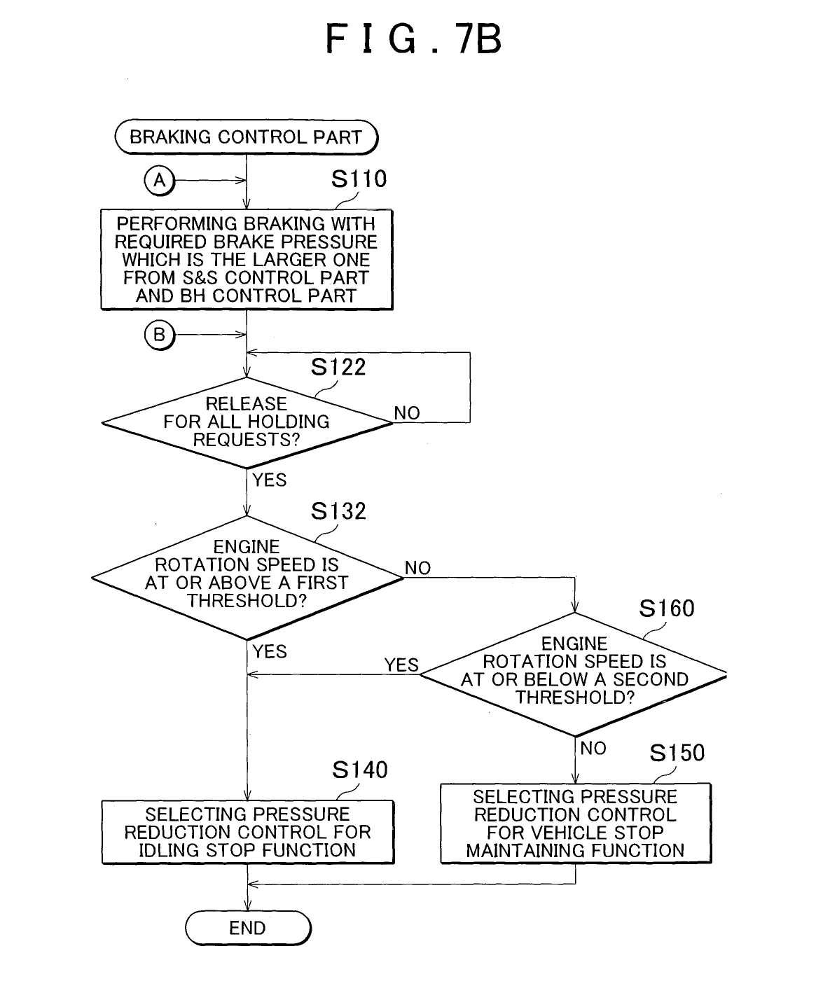

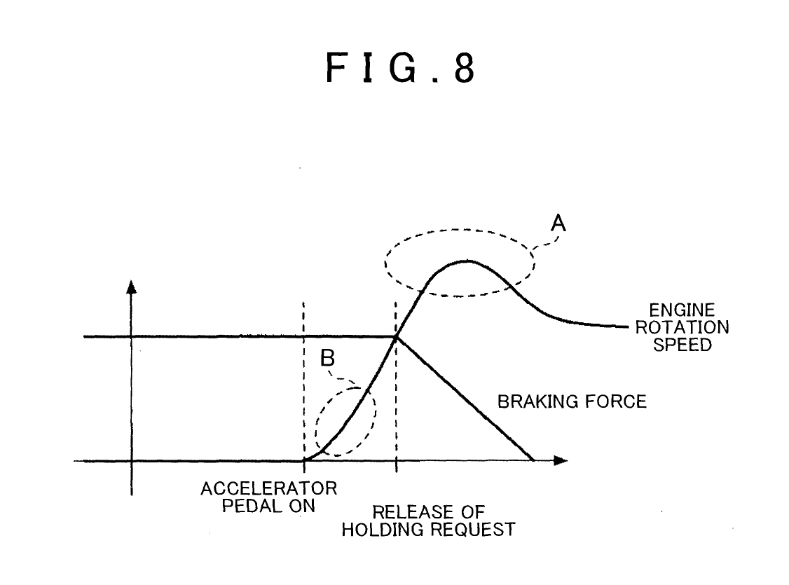

FIG. 7A and FIG. 7B are exemplary flowcharts for illustrating the operation sequence of the braking control part 43 of the present embodiment. Among the steps of FIG. 7A, steps S132 and S160 are different from FIGS. 6A and 6B, thus, steps S132 and S160 will be mainly described. In addition, FIG. 8 is a diagram for illustrating the determination of the engine rotation speed in step S132 and step S160. In addition, FIG. 7B shares common characterizing portions with FIG. 6B and FIG. 7A, thus the description thereof is omitted.

In the case where the accelerator pedal is ON (YES in S120), the pressure reduction control selecting part 46 determines whether or not the engine rotation speed is at or above a first threshold (S132). The engine rotation speed is detected by the crank angle sensor.

As shown in FIG. 8, the engine rotation speed concerned in step S132 is a rotation speed of excessive increase near the dashed line A. In the case where such a rotation speed which is higher than the idling speed is observed, it can be determined that the engine has been started. In addition, the first threshold may be, for example, about “the idling speed plus 200 rpm”. Since the idling speed can be detected by the crank angle sensor, the first threshold can be dynamically determined. In addition, considering the variation range of the idling speed, the first threshold may also be a fixed value.

In the case where the engine rotation speed is at or above the first threshold (YES in S132), the pressure reduction control selecting part 46 selects the pressure reduction control for the idling stop function (S140). That is, since the engine rotation speed is increased immediately after the accelerator pedal is depressed, it can be determined that the engine is started due to ON of the accelerator pedal.

When the engine rotation speed is not at or above the first threshold (NO in S132), the pressure reduction control selecting part 46 determines whether or not the engine rotation speed is at or below a second threshold (S160).

As shown in FIG. 8, the engine rotation speed concerned in step S160 is a rotation speed near the dashed line B prior to excessive increase. In the case where a rotation speed which is much lower than the idling speed and higher than zero is observed, it can be determined that the start of engine has taken place. In addition, the second threshold may be, for example, about 200 rpm. The second threshold may be a fixed value, or may be dynamically determined, such as being 10˜20% of the idling speed.

In the case where the engine rotation speed is at or below the second threshold (YES in S160), the pressure reduction control selecting part 46 selects the pressure reduction control for the idling stop function (S140). That is, since the start of the engine begins immediately after the accelerator pedal is depressed, it can be determined that the engine is started due to ON of the accelerator pedal.

In the present embodiment, by determining that the cause for starting the engine is ON of the accelerator, it is possible to deduce that both the vehicle stop maintaining function and the idling stop function are in operation, and thus, by delaying the pressure reduction, the shock upon starting-off can be suppressed.

When the engine rotation speed is not at or below the second threshold (NO in S160), the pressure reduction control selecting part 46 selects the pressure reduction control for the vehicle stop maintaining function (S150). In this case, since the engine rotation speed is about the idling speed, the engine has already been started when the accelerator pedal is depressed or the engine is started due to OFF of the brake pedal and/or the remaining capacity of the battery (since the cause for starting the engine is not ON of the accelerator pedal), and thus like in FIG. 6A, the pressure reduction control for the vehicle stop maintaining function is selected, and by advancing the pressure reduction, it is possible to start the vehicle with a good start response.

According to the present embodiment, the pressure reduction control can be suitably selected based on the engine rotation speed, rather than based on whether or not the engine is started due to ON of the accelerator pedal.

### Third Embodiment

In the present embodiment, a control apparatus for a vehicle which selects the pressure reduction control based on whether or not the release for all the holding requests has been received within a certain period since the engine is started.

In addition, since the structural diagram and/or functional block diagram has the same function as that in the first embodiment, only the main constitution elements of the present embodiment will be mainly described.

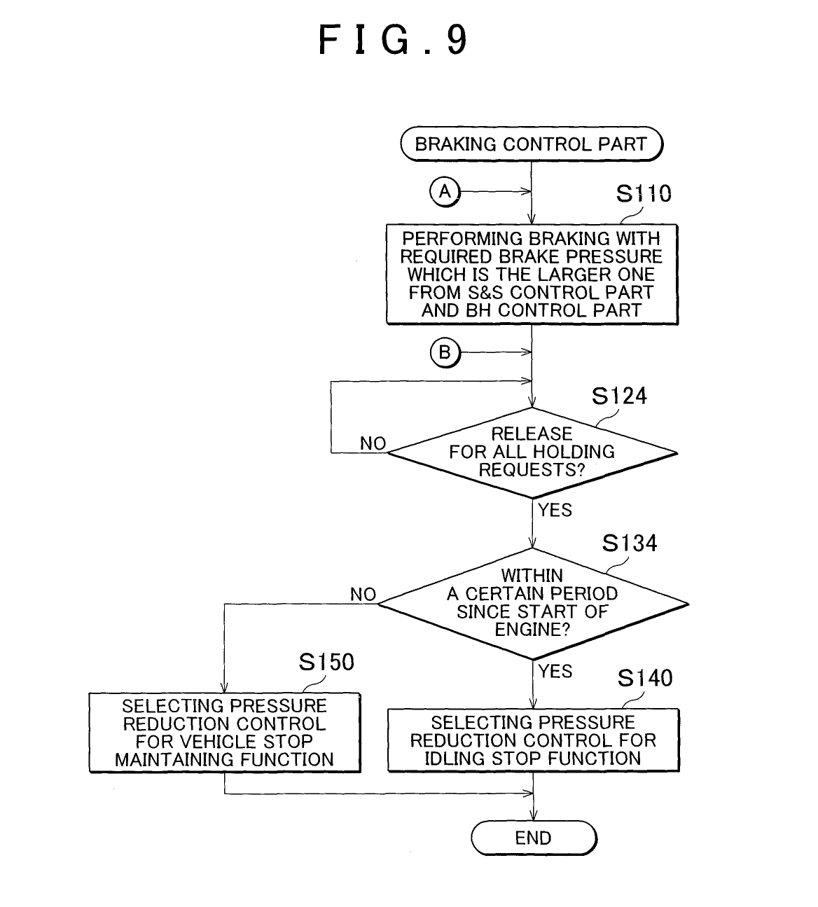

FIG. 9 is an exemplary flowchart for illustrating the operation sequence of the braking control part 43 of the present embodiment.

The braking control part 43 performs braking with the larger one of the required brake pressures of the S&S control part 41 and the BH control part 42 (S110). In the case where the holding request is received only from one of the two parts, the braking is performed with the required brake pressure by the received holding request.

The pressure reduction control selecting part 46 determines whether or not a release for the holding request has been output for all the holding requests (S124). That is, in the case where only the BH control part 42 output the holding request, it is determined whether or not the release for the holding request has been output from the vehicle stop maintaining function. In the case only the S&S control part 41 outputs the holding request, it is determined whether or not the release for the holding request has been output from the S&S control part 41. In the case where both the BH control part 42 and the S&S control part 41 output the holding requests, it is determined whether or not both the BH control part 42 and the S&S control part 41 output the release for the holding requests.

In the case where the release for the holding request has been output for all the holding requests (YES in S124), the pressure reduction control selecting part 46 determines whether it is within a certain period since the start of the engine (S134). That is, it is determined whether or not a period from a time at which the engine is started to a time at which the release for all the holding request is output is within a certain period. In addition, the certain period may be, for example, a short time such as 1 second to several seconds. In the case where only the BH control part 42 outputs the release for the holding request, since the engine is not stopped or started by the idling stop function, the lapsed time from the engine is started is at least several seconds or more. In the case where only the S&S control part 41 outputs the release for the holding request, the engine is started by OFF of the brake pedal, the release for the holding request is output from the S&S control part 41 within 1 second to several seconds at latest. In the case where the BH control part 42 and the S&S control part 41 both output the release for the holding requests, as shown in FIG. 1B, the BH control part 42 outputs the release for the holding request at a timing generally same as the timing at which the engine is started, and the S&S control part 41 outputs the release for the holding request within 1 second to several second at latest since the engine is started.

Therefore, if the time from the engine is started to the release for all the holding requests has been output is within a certain period, it can be determined that the engine is started by the S&S control part 41.

In the case where the time from the engine is started to the release for all the holding requests has been output is within a certain period (YES in S134), the pressure reduction control selecting part 46 selects the pressure reduction control for the idling stop function (S140). That is, since the engine is started by the idling stop function, by delaying the pressure reduction, the shock upon starting-off can be suppressed.

In the present embodiment, in the case where the engine is started by the S&S control part 41 due to a cause other than ON of the accelerator pedal, such as OFF of the brake pedal, it is also possible to select the pressure reduction control for the idling stop function.

In the case where the time from the engine is stared to the release for all the holding requests has been output is not within a certain period (NO in S134), the pressure reduction control selecting part 46 selects the pressure reduction control for the vehicle stop maintaining function (S150). That is, since the engine is not started by the idling stop function, by advancing the pressure reduction, the vehicle can be started with a good start response.

According to the present embodiment, in addition to the effects obtained in the first and second embodiments, in the case where the engine is started by the S&S control part 41 due to a cause other than ON of the accelerator pedal, it is also possible to suppress the shock upon starting-off incurred by the start of the engine.

### Fourth Embodiment

In the present embodiment, a control apparatus for a vehicle which selects the pressure reduction control based on whether or not it is the S&S control part 41 that most lately performs the release of the holding request is described.

In addition, since the structural diagram and/or functional block diagram has the same function as that in the first embodiment, only the main constitution elements of the present embodiment will be mainly described.

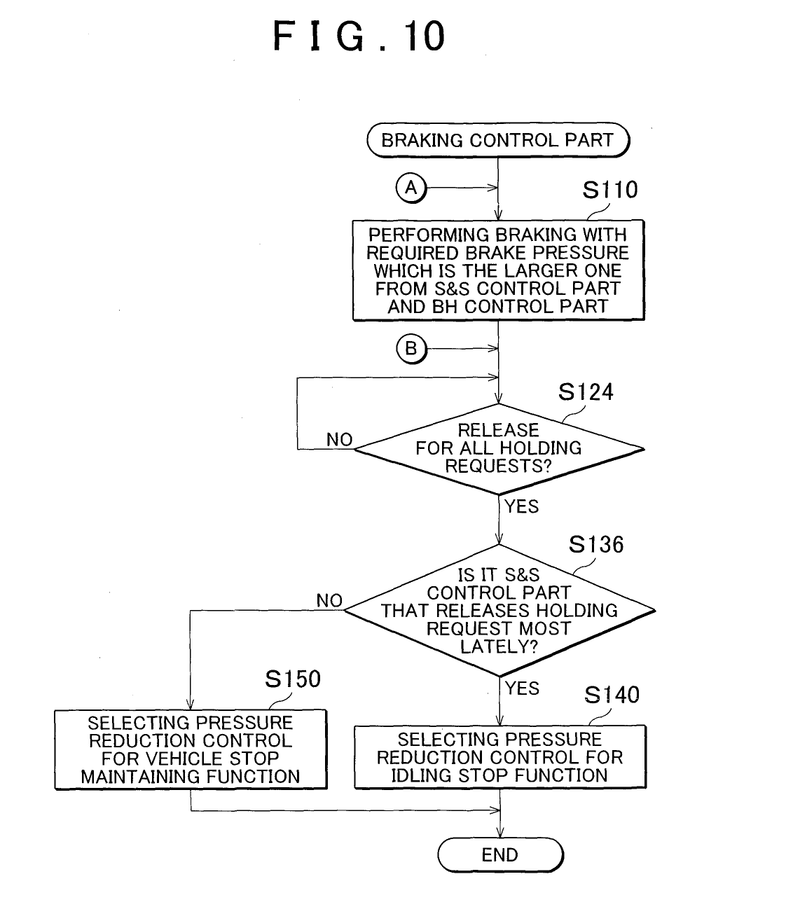

FIG. 10 is an exemplary diagram for illustrating the operation sequence of the braking control part 43 according to the present embodiment.

In the case where the holding requests are received from both the idling stop function and the vehicle stop maintaining function, the braking control part 43 performs braking with the larger one of the required brake pressures of the S&S control part 41 and the BH control part 42 (S110). In the case where the holding request is received from only one of the two parts, the braking is performed with the required brake pressure by the received holding request.

The pressure reduction control selecting part 46 determines whether or not the release for all the holding requests has been output (S124).

In the case where the release for all the holding request has been output (YES in S124), the pressure reduction control selecting part 46 determines whether or not it is the S&S control part 41 that releases the holding request most lately (S136). As shown in FIG. 1, the BH control part 42 outputs the release for the holding request immediately after the accelerator pedal is depressed, while the S&S control part 41 outputs the release for the holding request in a predetermined time after the accelerator pedal is depressed (until an engine rotation speed for complete combustion). Also, in the case where only the S&S control part 41 outputs the holding request and only the S&S control part 41 releases the holding request, it is the S&S control part 41 that releases the holding request most lately. In contrast, in the case where only the BH control part 42 outputs the holding request and only the BH control part 42 releases the holding request, it is the BH control part 42 that releases the holding request most lately.

Therefore, in the case where the engine is restarted, in the control parts outputting the holding requests, the S&S control part 41 releases the holding request most lately. In the present embodiment, the pressure reduction control is selected by considering this factor.

In addition, in the control for maintaining the vehicle stop state, there is a Hillstart Assist Control (HAC) system, and so on. However, since the Hillstart Assist Control system also releases the holding request due to ON of the accelerator pedal, the same determination can be applied. That is, the vehicle can also be equipped with other vehicle stop maintaining control which releases the holding request due to ON of the accelerator pedal.

In the case where it is the S&S control part 41 that releases the holding request most lately (YES in S136), the pressure reduction control selecting part 46 selects the pressure reduction control for the idling stop function (S140). That is, since the engine is restarted by the idling stop function, by delaying the pressure reduction, the shock upon starting-off can be suppressed.

In the case where it is not the S&S control part 41 that, releases the holding request most lately (NO in S136), the pressure reduction control selecting part 46 selects the pressure reduction control for the vehicle stop maintaining function (S150). That is, since the engine is not restarted by the idling stop function, by advancing the pressure reduction, the vehicle can be started with a good start response.

According to the present embodiment, the pressure reduction control can be suitably selected without monitoring the accelerator pedal and/or the engine rotation speed. Like in the third embodiment, even in the case where the engine is started by the S&S control part due to a cause other than ON of the accelerator pedal, it is possible to suppress the shock upon starting-off incurred by the start of the engine.

Modes for carrying out the invention have been described above by way of embodiments thereof, however, the invention is in no way limited to these embodiments, and various modifications and substitutions can be made without departing from the scope of the gist of the invention.

For example, the selection of the pressure reduction control in two or more of the first to fourth embodiments may be suitably combined with each other. For example, it may be determined as YES if both S120 or S122 in the first and second embodiments and S124 in the third and fourth embodiments are met, and it may also be determined as YES if S130 and S132 (S160) in the first and second embodiments, step S134 in the third embodiment and step S136 in the fourth embodiment are all met.

While in the present embodiments, the vehicle having an engine as a power source has been described by way of example, the present invention can also be applied to a vehicle in which an electric motor is used as a power source in additional to the engine

In addition, the engine start condition and the engine stop condition for the S&S control part 41 or the vehicle stop maintenance actuation operation of the BH control part 42 can be suitably set, and thus should not be limited to the situations as listed in the above embodiments.

In addition, hydraulic pressure is used to control the braking force in the present embodiments. However, in a vehicle that uses an electric brake to control the braking force, the pressure reduction control of the present embodiments is performed by the electric brake. In addition, in the case where a part of the braking force is provided by the electric brake, the pressure reduction control of the present embodiments may be realized by either of hydraulic pressure brake or electric brake. In addition, a part of the braking force can also be provided by a parking brake.

1. A control apparatus for a vehicle, comprising:
a stop-restart unit that stops an engine if an engine stop condition is satisfied and that restarts the engine if a restart condition is satisfied;
a braking force maintenance unit that maintains a braking force for stopping the vehicle; and
a braking force reduction unit that reduces the maintained braking force in different manners depending on whether or not the engine is restarted by the stop-restart unit, in the case where the vehicle is being braked by the braking force maintenance unit,
wherein the braking force reduction unit reduces the braking force in the case where a release request for the braking force is received from the stop-restart unit and the braking force maintenance unit, and the braking force reduction unit reduces the maintained braking force in a first braking force reduction manner in the case where all the requests for the braking force have been released within a predetermined period after the engine is started, and reduces the maintained braking force in a second braking force reduction manner in the case where not all the requests for the braking force have been released within the predetermined period after the engine is started.

2-6. (canceled)

7. The control apparatus according to claim 1, wherein
by the first braking force reduction manner, the braking force is reduced to a predetermined value in a longer time than by the second braking force deducting manner.

8. A control method of a control apparatus for a vehicle including a stop-restart unit that stops an engine if an engine stop condition is satisfied and that restarts the engine if a restart condition is satisfied, and a braking force maintenance unit that maintains a braking force for stopping the vehicle, the control method comprising:
reducing the maintained braking force in different manners depending on whether or not the engine is restarted by the stop-restart unit, in the case where the vehicle is being braked by the braking force maintenance unit,
reducing the braking force in the case where a release request for the braking force is received from the stop-restart unit and the braking force maintenance unit,
reducing the maintained braking force in a first braking force reduction manner in the case where all the requests for the braking force have been released within a predetermined period after the engine is started, and
reducing the maintained braking force in a second braking force reduction manner in the case where not all the requests for the braking force have been released within the predetermined period after the engine is started.
